(19) United States
(12) Patent Application Publication
(10) Pub. No.: US 2021/0235004 A1
(43) Pub. Date: Jul. 29, 2021

(54) SELECTIVE ILLUMINATION ROLLING SHUTTER IMAGING SYSTEM

(71) Applicant: Gentex Corporation, Zeeland, MI (US)

(72) Inventor: Ryan T. Duguay, Hudsonville, MI (US)

(73) Assignee: Gentex Corporation, Zeeland, MI (US)

(21) Appl. No.: 16/750,340

(22) Filed: Jan. 23, 2020

(51) Int. Cl. H04N 5/235; H04N 5/232; B60R 25/02; B60R 25/25; B60R 25/30

(52) U.S. Cl. CPC H04N 5/2352; H04N 5/23219; B60R 25/305; B60R 25/25; B60R 25/02

(57) ABSTRACT

A system comprises an illumination source, an imager and a controller. The illumination source is operable to illuminate a subject in a spectrum. The imager is operable to perform a rolling shutter operation and image a subject in the spectrum. The system is operable to selectively illuminate the subject during an exposure of a first part of a first frame. The controller is operable to record an image of the first frame.

### FIELD OF INVENTION

The present invention relates in general to imaging devices and, more particularly, to illumination for an imager operable to perform a rolling shutter operation.

### BACKGROUND OF INVENTION

Devices for imaging subjects have been well known for many years. Further, imaging and illuminating in the infra-red spectrum have the advantage of being outside of the spectrum visible to the human eye. Accordingly, when the subject is illuminated, the subject does not see the projected infra-red light. Nonetheless, infra-red light is harmful to human skin and eyes. Accordingly, there is a need for an improved system of imaging and illuminating a subject in the infra-red spectrum.

Additionally, infra-red imaging commonly uses an imager with a global shutter. However, imagers with rolling shutters—while offering superior frame rates, sensitivity, and size—can be problematic for infra-red imaging. Typically, LEDs used for illumination, pulse at high rates, creating poor, inconsistent, and unpredictable imaging. For example, streaking may occur across images, potentially blocking out key features of the image. Accordingly, LEDs are kept on long enough to allow for illumination during an entire exposure period for a frame, when used with a rolling shutter. However, this is problematic as it consumes large amounts of energy and emits large amounts of infra-red light and heat. Therefore, there is a need for an improved system of imaging and illuminating a subject with a rolling shutter imager.

### SUMMARY

In accordance with the present disclosure, the disadvantages and problems associated with using LED's with a rolling shutter imager have been substantially reduced or eliminated, particularly in the context of imaging in the infra-red spectrum.

In accordance with one embodiment of the present disclosure, a system is disclosed. The system comprises an illumination source, an imager, and a controller. The imager is operable to perform a rolling shutter operation and image in a spectrum. The illumination source is operable to illuminate a subject in the spectrum, and further operable to selectively illuminate the subject during an exposure of a first part of a first frame. The controller is operable to record an image of the first frame and analyze the image to determine if a biometric signature is substantially present in the first part. If the biometric signature was not substantially present in the first part, the illumination source is further operable to selectively illuminate the subject during an exposure of a second part of a second frame and the controller is operable to record an image of the second frame.

In accordance with another embodiment of the present disclosure, a method of imaging is disclosed. The method comprises the steps of selectively illuminating for a first frame, a first portion of a frame exposure period; recording an image of the first frame; determining whether a biometric signature is present in a first image from the first frame; and based on a determination that the biometric signature is not present in the first part, selectively illuminating, for a second frame, a second portion of a frame exposure period.

In accordance with another embodiment of the present disclosure, a device is disclosed. The device comprises an illumination source, an imager, and a controller. The imager has a rolling shutter and is operable to image a series of frames in a spectrum. The illumination source is operable to selectively illuminate for a first portion of a frame exposure period for a first frame. The controller is operable to determine whether a biometric signature is present in a first part of the first frame corresponding to the first portion. Additionally, in response to a determination that the biometric signature is not present in the first part of the first frame, the illumination source is operable to selectively illuminate, for a second portion of a frame exposure period for a second frame. Further, the second portion is unique from the first portion.

The technical advantages of certain embodiments of the present disclosure include: enabling the use of an imaging system, particularly in the infra-red spectrum, with a rolling shutter that produces quality, consistent, predictable imaging as well as reducing IR exposure levels, energy consumption, and heat production, by allowing for the control of illuminated zones—and thus also un-illuminated zones—such that a zone of interest in a field of view is illuminated while also minimizing the duration of which the illumination occurs.

### BRIEF DESCRIPTION OF FIGURES

FIG. 1: Schematic drawing of a rolling shutter imaging system with selective illumination.

FIG. 2a: Diagram of selectively illuminating during a frame.

FIG. 2b: Diagram of selectively illuminating during a frame.

FIG. 2c: Diagram of selectively illuminating during a frame.

FIG. 2d: Diagram of selectively illuminating during a frame.

FIG. 3: Schematic drawing of a rear-view mirror assembly.

FIG. 4: Process flow diagram for rolling shutter imaging with selective illumination.

### DETAILED DESCRIPTION

For the purposes of description herein, it is to be understood that the specific devices and processes illustrated in the attached drawings and described in this disclosure are simply exemplary embodiments of the inventive concepts defined in the appended claims. Hence, specific dimensions and other physical characteristics relating the embodiments disclosed herein are not to be considered as limiting, unless the claims expressly state otherwise.

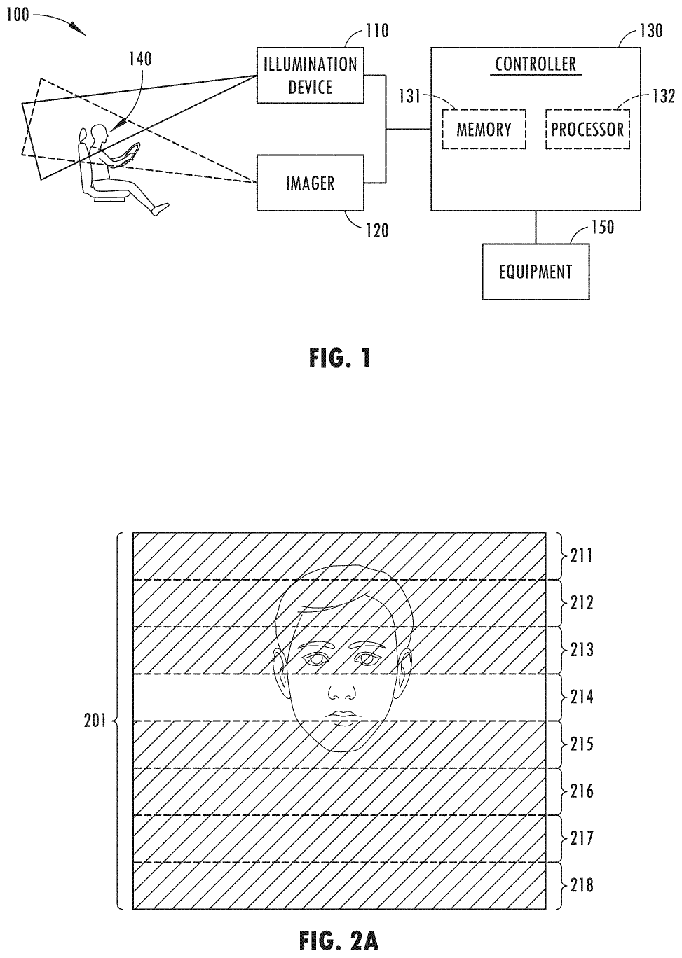

FIG. 1 illustrates a schematic drawing of a rolling shutter imaging system with selective illumination 100. A rolling shutter imaging system with selective illumination 100 generally comprises an illumination device 110, an imager 120, and a controller 130.

Illumination device 110 may be any device operable to emit light in a spectrum. In some embodiments, the spectrum may be an infra-red (“IR”) spectrum. For example, illumination device 110 may be a light emitting diode (“LED”), halogen, quartz, incandescent, or compact fluorescent (“CFL”) light bulb. It is preferable that IR illumination device 110 primarily emits in the non-visible spectrum and optimal that it limits its emission to the non-visible spectrum.

Imager 120 may be any device operable to perform a rolling shutter operation and capture light in the spectrum to produce a digital image. For example, imager 120 may be a camera. Additionally, it is preferable that imager 120 is disposed such that light reflected off a subject 140 is substantially directed to imager 120.

A rolling shutter operation is a method of image exposure, in which a frame is captured, not by taking a snapshot of an entire scene at a single instant in time by exposing the entire field of view simultaneously—as done in a global shutter operation—but by sweeping across the frame. In other words, not all parts of the frame are recorded at exactly the same instant (though this process is often very fast, and the resulting frame image may appear as such). The rolling shutter operation may be either mechanical or electrical.

Controller 130 is operably connected to IR illumination device 110 and imager 120. Further, controller 130 may be any device operable to control the illumination of illumination device 110, to control the imaging of imager 120, record images from imager 120, and process the images from imager 120. Controller 130 may comprise a memory 131 and a processor 132. Controller 130 may also be connected to one or more pieces of equipment 150 and operable to reconfigure equipment 150, for a specific subject.

Memory 131 may be operable to store one or more of: a biometric signature detection algorithm, a biometric processing algorithm, one or more subject profile, and one or more image. The biometric signature detection algorithm may be operable to determine if a biometric signature is present in an image or in a particular area of an image. The biometric signature, for example, may comprise one or more facial feature for facial recognition or iris structure for an iris scan. The biometric processing algorithm may be operable to analyze a biometric signature from an image and match the biometric signature to a subject profile. The subject profile may comprise one or more preference or one or more authorization for one or more pieces of equipment 150.

Equipment 150 may be, for example, a vehicle, a vehicle computer, a mirror, a window, a radio, a dashboard, a steering wheel, a foot pedal system, or a lighting system. It is further contemplated that the equipment preference may be, for example, a seat position, window tint level, radio station, radio volume, maximum vehicle speed, driving mode, dashboard illumination, mirror position, rearview display vs mirror preference, steering wheel position, pedal position, or lighting level or color.

It is further contemplated that the subject profile may be created and/or modified in a number of ways. One such method is to have subject 140 manually input their preferences. Another method is to have memory 131 store equipment 150 configurations and optionally the conditions surrounding the configurations, when in use by subject 140, over time. Accordingly, controller 140 may use an artificially intelligent or pattern recognition algorithm to analyze the stored data and synthesize and or modify a subject profile. Further, controller 130 may use an artificially intelligent or pattern recognition algorithm to adapt or modify the subject profile.

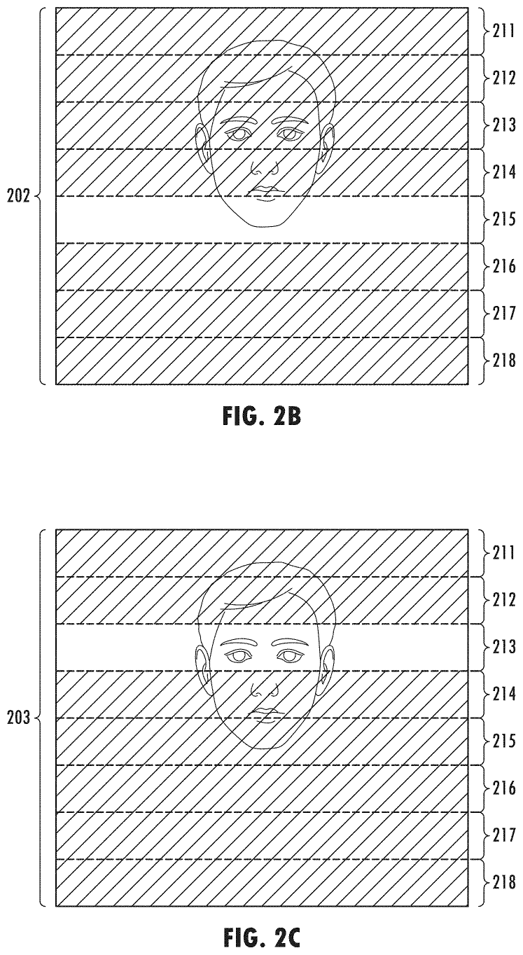

In operation, rolling shutter imaging system 100, captures a biometric signature of subject 130. Imager 120 images subject 140 to capture the biometric signature. An example of this operation is illustrated by FIGS. 2a-d. To capture the biometric signature in an image, imager 120 may take a series of images, each corresponding to a frame 201-204.

A frame 201-204 is an entire field of view of imager 120 at a segment of time corresponding to an exposure period. The exposure period is the period of time it takes for a shutter of imager 120 to make a complete sweep across a frame 201-204, exposing the entire field of view. Further, a frame 200 may be broken up into a plurality of zones 211-218. It is herein contemplated that zones 211-218 may be of any size, any number, oriented in any direction, continuous or interrupted, and/or exclusive of or overlapping with another zone 211-218.

During a successive series of frames 201-204, IR illumination device 110 selectively illuminates during a portion of the exposure period at which a zone 211-218 is exposed, for each frame—in other words, illumination device 110 illuminates during only part of the exposure period. After imaging an initial frame 201, controller 130 records the image and runs the biometric signature detection algorithm to determine if a biometric signature is substantially present in the illuminated zone of frame 201. If the biometric signature is not substantially present in the illuminated zone 214, then a subsequent frame 202-204 is imaged where the portion of the exposure period of which the illumination device 110 illuminates is different from the portion of the exposure period in which the biometric signature was not substantially present in the corresponding image. In other words, a different zone 211-218 of the field of view is illuminated in subsequent frame 202-204. This process repeats itself until the biometric signature is determined substantially present in the illuminated zone of a frame 201-204. For example, rolling shutter imaging system 100 may repeatedly capture images, searching until a pair of eyes are substantially found in an illuminated zone. Further, it is contemplated that the illumination of zones 211-218 may proceed in any order. For example, the illumination of zones 211-218 may occur in a spatially linear series, skip around randomly, or skip around based on a statistical probability of the biometric signature being within each zone.

After the biometric signature is determined substantially present in the illuminated zone of a frame 201-204, controller 130 runs the biometric processing algorithm to pull biometric data from the resulting image such that a biometric signature may be determined and matched with a user profile, for identification. Optionally, rolling shutter imaging system 100 may capture additional images, during which the illuminated zone remains the same as the zone in which the biometric signature was previously found.

For example, this process is illustrated in FIGS. 2a-2d. In FIG. 2a, frame 201 is imaged wherein zone 214 is illuminated. However, the biometric signature—in this case a pair of eyes—is not substantially present in the illuminated zone 214. Accordingly, rolling shutter imaging system 100 moves on to FIG. 2b where frame 202 is imaged and zone 215 is illuminated. However, again, the eyes are not substantially present in illuminated zone 215. Therefore, rolling shutter imaging system 100 moves on to FIG. 2c where frame 203 is imaged and zone 213 is illuminated. This time, the eyes are substantially present in illuminated zone 213. At this point, rolling shutter imaging system 100 optionally moves on FIG. 2d where frame 204 is imaged and zone 215 is again illuminated.

Once the user profile has been matched to the biometric signature, the rolling shutter imaging system 100 may optionally match the biometric signature to a subject profile and unlock a door and/or implement preferences onto one or more pieces of equipment 150 based on the subject profile.

The present disclosure has the technical advantage of enabling the use of an imaging system with a rolling shutter that produces quality, consistent, predictable imaging as well as reducing IR exposure levels, energy consumption, and heat production, by allowing for the control of illuminated zones—and thus also un-illuminated zones—such that a zone of interest in a field of view is illuminated while also minimizing the duration of which the illumination occurs.

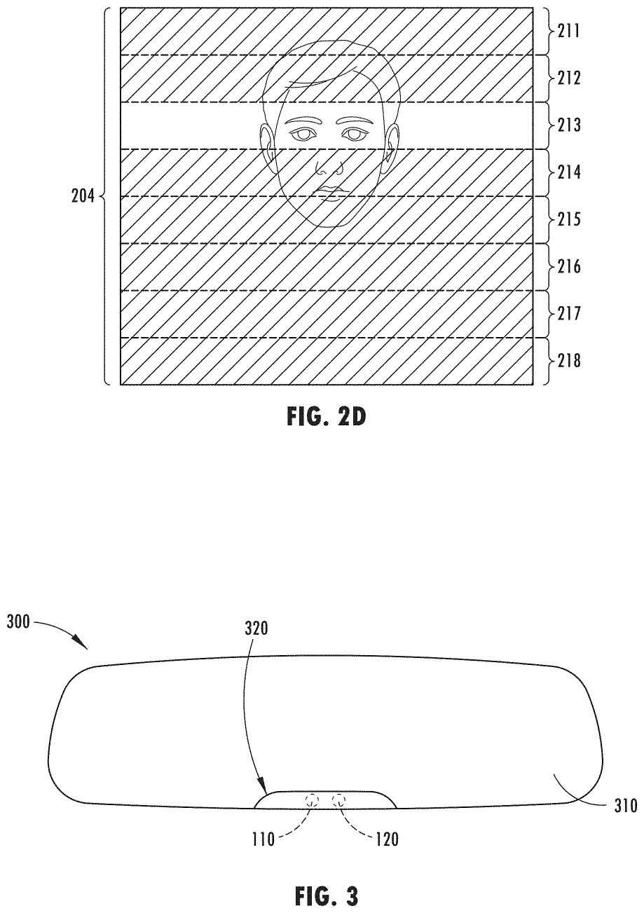

FIG. 3 illustrates a schematic representation of a rear-view mirror assembly 300 with a rolling shutter imaging system having selective illumination. It is contemplated that the rear-view mirror assembly 300 may be any mirror or display capable of providing a subject with a view in the rear-ward direction of a vehicle. For example, the rear-view mirror assembly 300 may comprise an interior rear-view mirror or an exterior side rear-view mirror.

The rear-view mirror assembly 200 comprises a reflecting portion 310, an illumination device 110, and an imager 120. It is contemplated that illumination device 110 and imager 120 may be disposed on, in, or adjacent to a rearview mirror.

Reflecting portion 310 comprises a substrate substantially reflective in the visible spectrum. Additionally, reflecting portion 310 may further comprise an electrochromic element.

Illumination device 110 may be any device operable to emit light in a spectrum. In some embodiments, the spectrum may be an IR spectrum. For example, IR illumination device 110 may be a light emitting diode (“LED”), halogen, quartz, incandescent, or compact fluorescent (“CFL”) light bulb. It is preferable that illumination device 110 primarily emits in the non-visible spectrum and optimal that it limits its emission to the non-visible spectrum. Further, illumination device 110 is configured for connection to a controller.

Imager 120 may be any device operable to perform a rolling shutter operation and capture light in the IR spectrum to produce a digital image. For example, imager 120 may be a camera. Additionally, it is preferable that imager 120 is disposed such that IR light reflected off a subject 140 is substantially directed to imager 120. Further, Imager 120 is configured for connection to a controller.

A rolling shutter operation is a method of image exposure, in which a frame is captured not by taking a snapshot of an entire scene at a single instant in time by exposing the entire field of view simultaneously—as done in a global shutter operation—but by sweeping across the frame. In other words, not all parts of the frame are recorded at exactly the same instant (though this process is often very fast and the resulting frame image may appear as such). The rolling shutter operation may be either mechanical or electric.

In one embodiment, rear-view mirror assembly 300 further comprises an imaging window 320. It is contemplated that imaging window 320 may be placed in any location of a rear-view mirror assembly, such as, for example, in one of the corners or on the bottom center. In such an embodiment, illumination device 110, and imager 120 are disposed behind and in optical communication with imaging window 320. Imaging window 320 may comprise a substrate transmissive in the IR spectrum. Optionally, imaging window 320 may further comprise a substrate substantially opaque in the visible spectrum.

In operation, rear-view mirror assembly 300 captures a biometric signature of a subject. Imager 120 images the subject in a series of images, each corresponding to a frame, to capture the biometric signature.

A frame is an entire field of view of imager 120 at a segment of time corresponding to an exposure period. The exposure period is the period of time it takes for a shutter of imager 120 to make a complete sweep across a frame, exposing the entire field of view. Further, a frame may be broken up into a plurality of zones. It is herein contemplated that the zones may be of any size, of any number, oriented in any direction, continuous or interrupted, and/or exclusive of or overlapping with another zone.

During a successive series of frames, illumination device 110 selectively illuminates during a portion of the exposure period at which a zone is exposed, for each frame—in other words, illumination device 110 illuminates during only part of the exposure period. After imaging an initial frame, the controller records the image and runs the biometric signature detection algorithm to determine if a biometric signature is substantially present in the illuminated zone of the frame. If the biometric signature is not substantially present in the illuminated zone, then a subsequent frame is imaged where the portion of the exposure period of which illumination device 110 illuminates is different from the portion of the exposure period in which the biometric signature was not substantially present in the corresponding image. In other words, a different zone of the field of view is illuminated in a subsequent frame. This process repeats itself until the biometric signature is determined substantially present in the illuminated zone of a frame. For example, rear-view mirror assembly may repeatedly capture images, searching until a pair of eyes are substantially found in an illuminated zone. Further, it is contemplated that the illumination of the zones may proceed in any order. For example, the illumination of the zones may occur in a spatially linear series, skip around randomly, or skip around based on a statistical probability of the biometric signature being within each zone.

After the biometric signature is determined substantially present in the illuminated zone of a frame, controller 130 runs the biometric processing algorithm to pull biometric data from the resulting image such that a biometric signature may be determined and matched with a user profile, for identification. Optionally, imager 120 may capture additional images, during which the illuminated zone remains the same as the zone in which the biometric signature was previously found.

The present disclosure has the technical advantage of enabling the use of an imaging system with a rolling shutter that produces quality, consistent, predictable imaging as well as reducing IR exposure levels, energy consumption, and heat production, by allowing for the control of illuminated zones—and thus also un-illuminated zones—such that a zone of interest in a field of view is illuminated, while also minimizing the duration of which the illumination occurs. Additionally, when illumination device 110 and imager 120 are disposed behind and in optical communication with imaging window 320, the present disclosure has the technical advantage of concealing the componentry and providing a clean sleek aesthetic appearance.

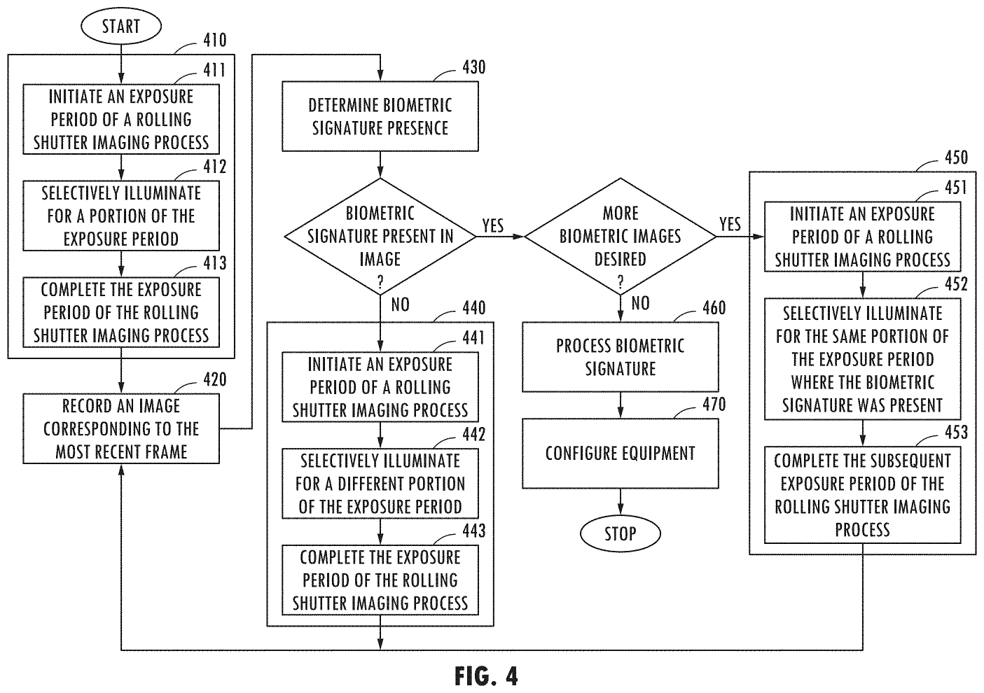

FIG. 4 is a process flow diagram for rolling shutter imaging with selective illumination. The process comprises the steps of imaging an initial frame 410; recording an image corresponding to the most recent frame 420; determining if a biometric signature is present an illuminated zone of the frame 430; if the biometric signature is not present: imaging a subsequent frame 440, recording an image corresponding to the most recent frame, and determining if a biometric signature is present in an illuminated zone of the frame 430; and once a biometric signature is determined present: processing the biometric signature 460.

The process starts with imaging an initial frame 410. The imaging is conducted by an imager. The imager may be any device operable to perform a rolling shutter operation and capture light in a spectrum to produce a digital image. For example, the imager may be a camera. Further, the spectrum may be an IR spectrum. A rolling shutter imaging process is a method of image exposure, in which a frame is captured not by taking a snapshot of an entire scene at a single instant in time by exposing the entire field of view simultaneously—as done in a global shutter operation—but by sweeping across the frame. In other words, not all parts of the frame are recorded at exactly the same instant (though this process is often very fast and the resulting frame image may appear as such). The rolling shutter operation may be either mechanical or electric.

Further, a frame is an entire field of view of the imager at a segment of time corresponding to an exposure period. The exposure period is the period of time it takes for a shutter of the imager to make a complete sweep across a frame, exposing the entire field of view. Further, a frame may be broken up into a plurality of zones. It is herein contemplated that the zones may be of any size, any number, oriented in any direction, continuous or interrupted, and/or exclusive of or overlapping with another zone.

The step of imaging an initial frame 410 comprises the steps of initiating an exposure period of a rolling shutter imaging process 411, selectively illuminating for a portion of the exposure period 412, and completing the initial exposure period of a rolling shutter imaging process 413.

In step 411, a rolling shutter exposure period begins. Subsequently, in step 412, an illumination device selectively illuminates during a portion of the exposure period at which a zone is exposed—in other words, the illumination device illuminates during only part of the exposure period. The illumination device may be a device operable to emit light in the IR wavelength spectrum. For example, the illumination device may be a light emitting diode (“LED”), halogen, quartz, incandescent, or compact fluorescent (“CFL”) light bulb. It is preferable that the illumination device primarily emits in the non-visible spectrum and optimal that it limits its emission to the non-visible spectrum. Finally, the exposure period is completed 413, resulting in the complete exposure of a frame.

After imaging frame 410, 440, or 450, a controller records an image of the most recent frame 420. Upon recording the image, the controller additionally determines if a biometric signature is present in the illuminated zone of the frame 430. A biometric signature, for example, may comprise one or more facial feature for facial recognition or iris structure for an iris scan. The controller determines if the biometric signature is present in the illuminated zone by running a biometric signature detection algorithm.

If a biometric signature is not substantially present in the illuminated zone, then a subsequent frame is imaged 440. The process of imaging a subsequent frame 440 is generally the same as imaging the initial frame 410, with the exception that the portion of the exposure period of which the illumination device illuminates is different from the portion of the exposure period in which the biometric signature was not substantially present previously. In other words, a different zone of the field of view is illuminated in subsequent frame. Likewise, the imaging of the subsequent frame 440 is followed by recording the image 420 and determining if a biometric signature is present in the illuminated zone 430.

The above process of imaging subsequent frames 440 repeats itself until the biometric signature is determined substantially present in the illuminated zone of a frame. For example, a rolling shutter imaging system may repeatedly capture images, searching until a pair of eyes are substantially found in an illuminated zone. Further, it is contemplated that the illumination of zones may proceed in any order. For example, the illumination of zones may occur in a spatially linear series, skip around randomly, or skip around based on a statistical probability of the biometric signature being within each zone.

Once a biometric signature is determined substantially present in the illuminated zone, the process may proceed to a step of imaging an optional frame 450. The process of imaging an optional frame 450 is generally the same as imaging the initial frame 410, with the exception that the portion of the exposure period of which the illumination device illuminates is the same as the portion of the exposure period in which the biometric signature was substantially present. Likewise, the imaging of the optional frame 450 is by recording the image 420 and determining if a biometric signature is present in the illuminated zone 430 by recording the image 420 and determining if a biometric signature is present in the illuminated zone 430 by recording the image 420 and determining if a biometric signature is present in the illuminated zone 430. This process of imaging optional frames 450 may repeat itself until optional frames are no longer desired.

If a biometric signature is determined substantially present in the illuminated zone and no additional images are desired, then the biometric signature is processed 460. The biometric signature is processed by the controller. The controller runs a biometric processing algorithm to pull biometric data from the resulting image such that a biometric signature may be determined and matched with a user profile, for identification.

Additionally, after the biometric signature is processed 460, the process may optionally configure one or more pieces of equipment 470. The equipment may be, for example, a vehicle, a vehicle computer, a mirror, a window, a radio, a dashboard, a steering wheel, a foot pedal system, or a lighting system. The equipment may be configured such as to implement a subject's authorizations or preferences. It is contemplated that a subject's authorization, for example, may include, door access, maximum vehicle speed, radio volume, or driving mode. Additionally, it is contemplated that an equipment preference may be, for example, a seat position, window tint level, radio station, radio volume, driving mode, dashboard illumination, mirror position, rearview display vs mirror preference, steering wheel position, pedal position, or lighting level or color.

The present disclosure has the technical advantage of imaging in the spectrum with a rolling shutter that produces quality, consistent, predictable imaging as well as reducing IR exposure levels, energy consumption, and heat production, by allowing for the control of illuminated zones—and thus also un-illuminated zones—such that a zone of interest in a field of view is illuminated while also minimizing the duration of which the IR illumination occurs.

The terms “including,” “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. An element preceded by “comprises a . . . ” does not, without more constraints, preclude the existence of additional identical elements in the process, method, article, or apparatus that comprises the elements.

The term “substantially,” and variations thereof, will be understood by persons of ordinary skill in the art as describing a feature that is equal or approximately equal to a value or description. For example, a “substantially planar” surface is intended to denote a surface that is planar or approximately planar. Moreover, “substantially” is intended to denote that two values are equal or approximately equal. If there are uses of the term which are not clear to persons of ordinary skill in the art, given the context in which it is used, “substantially” may denote values within about 10% of each other, such as within about 5% of each other, or within about 2% of each other.

As used herein, the term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; A and C in combination; B and C in combination; or A, B, and C in combination.

In this document, relational terms, such as “first,” “second,” and the like, are used solely to distinguish one entity or action from another entity or action, without necessarily requiring or implying any actual such relationship or order between such entities or actions.

It is to be understood that although several embodiments are described in the present disclosure, numerous variations, alterations, transformations, and modifications may be understood by one skilled in the art, and the present disclosure is intended to encompass these variations, alterations, transformations, and modifications as within the scope of the appended claims, unless their language expressly states otherwise.

1. A system comprising:
an illumination source operable to illuminate in a spectrum;
an imager operable to:
perform a rolling shutter operation, and
image a subject in the spectrum; and
a controller;
wherein:
the illumination source is operable to selectively illuminate the subject during an exposure of a first part of a first frame,
the controller is operable to:
record an image of the first frame, and
analyze the image of the first frame and determine if a biometric signature is substantially present in the first part; and
based on a determination that the biometric signature was not substantially present in the first part:
the illumination source is further operable to selectively illuminate the subject during an exposure of a second part of a second frame, the second part different than the first part, and
the controller is operable to record an image of the second frame.

2. The system of claim 1 wherein:
the controller is further operable to analyze the image of the second frame and determine if the biometric signature is substantially present in the second part; and
based on a determination that the biometric signature was not present in the second part, the illumination source is further operable to selectively illuminate the subject, during a series of subsequent frames, during an exposure of a unique subsequent part for each subsequent frame.

3. The system of claim 1 wherein:
based on a determination that a biometric signature is substantially present in the second part:
the illumination source is further operable to selectively illuminate the subject during an exposure of a third part of a third frame; and
the controller is operable to record an image of the third frame;
wherein the second and third parts correspond to substantially equivalent zones of the imager's field of view.

4. The system of claim 1 wherein the controller is further operable to process the biometric signature.

5. The system of claim 4 wherein the controller is further operable to, based on the processing of the biometric signature, match the biometric signature with a subject profile.

6. The system of claim 1 wherein the device is further operable to:
selectively illuminate the subject during a plurality of frames, until a totality of the imager's field of view has been selectively illuminated; and
combine a plurality of images corresponding to the plurality of frames, to produce a combined image.

7. The system of claim 5 wherein the controller is operable to unlock a vehicle door based at least in part on the subject profile match.

8. The system of claim 5 wherein the subject profile comprises one or more of seat position, window tint, radio station, radio volume maximum, vehicle speed, driving mode, dash illumination, mirror position, mirror versus display selection, steering wheel position, pedal position, or lighting preference.

9. The system of claim 1 further comprising:
a housing; and
a rearview mirror;
wherein the housing substantially encloses the illumination source, the imager, and the rearview mirror.

10. The system of claim 9 wherein:
the rearview mirror comprises a reflecting portion and an imaging window; and
the imager is disposed behind and in optical communication with the imaging window.

11. The system of claim 9 wherein the rearview mirror is an internal rearview mirror.

12. The system of claim 1 wherein the spectrum is an infra-red spectrum.

13. A method of imaging comprising:
selectively illuminating for a first frame, a first portion of a frame exposure period;
recording an image of the first frame;
determining whether a biometric signature is present in a first part of the first fame substantially corresponding to the first portion; and
based on a determination that the biometric signature is not present in the first part, selectively illuminating, for a second frame, a second portion of a frame exposure period, the second portion different than the first portion.

14. The method of imaging of claim 13 further comprising processing the biometric signature.

15. The method of imaging of claim 14 further comprising matching the biometric signature with a subject profile.

16. The method of imaging of claim 15 further comprising unlocking a vehicle door based at least in part on the biometric signature.

17. The method of imaging of claim 13 further comprising:
determining whether a biometric signature is present in a second part of the second frame substantially corresponding to the second portion; and
based on a determination that the biometric signature was not present in the second part, selectively illuminating during a series of subsequent frames a unique portion of the frame exposure period for each subsequent frame.

18. A device comprising:
an illumination source operable to illuminate in a spectrum;
an imager with a rolling shutter and operable to image a series of frames in the spectrum; and
a controller;
wherein:
the illumination source is operable to selectively illuminate for a first portion of a frame exposure period for a first frame,
the controller is operable to determine whether a biometric signature is present in a first part of the first frame corresponding to the first portion, and
in response to a determination that the biometric signature is not present in the first part of the first frame, the illumination source is operable to selectively illuminate, for a second portion of a frame exposure period for a second frame, the second portion unique from the first portion.

19. The device of claim 18 wherein:
the controller is further operable to determine whether the biometric signature is present in the second portion of the second frame; and
in response to a determination that the biometric signature is present in the second part of the second frame:
the illumination source is operable to selectively illuminate for the second portion of a frame exposure period for a third frame.

20. The device of claim 18 wherein:
in response to a determination that the biometric signature is not present in the second part of the second frame:
the illumination source is further operable to selectively illuminate during a series of subsequent frames, for a series of unique portions of the frame exposure period for each subsequent frame, until the biometric signature is determined present in a part of a subsequent fame corresponding to the selectively illuminated portion of the frame exposure period,
wherein the controller determines whether the biometric signature is present in the part of each subsequent frame corresponding to the selectively illuminated portion of the frame exposure period.
